(19) United States
(12) Patent Application Publication
(10) Pub. No.: US 2004/0177064 A1
(43) Pub. Date: Sep. 9, 2004

(54) Selecting effective keywords for database searches

(75) Inventor: Junichi Satoh, Chigasaki-shi (JP)

Correspondence Address: David R. Irvin, IBM Corporation T81/503, P.O. Box 12195, Research Triangle Park, NC, 27709, US

(73) Assignee: International Business Machines Corporation, Armonk, NY

(21) Appl. No.: 10/681,603

(22) Filed: Oct. 8, 2003

(30) Foreign Application Priority Data
Dec. 25, 2002 (JP) 2002-375455

(51) Int. Cl. G06F 17/30

(52) U.S. Cl. 707/3

(57) ABSTRACT

An input interface for effectively selecting keywords for a database search, and a search system using the interface. A database search system includes a engine section, an input/output control section that controls entry of a keyword and output of a database search result, and a search system control section that determines a display manner of the keyword responsive to an effectiveness measure of the keyword such as a hit ratio or number of hits in the database. Before the search is executed, the search system control determines the display manner of the keyword. Display manners may specify various display colors, fonts, special symbols, and the like.

### FIELD OF THE INVENTION

The present invention relates to an input interface for selecting keywords that are effective for use in database searches.

### BACKGROUND

Databases using computers have now become widespread. Large-scale databases often include an enormous amount of data. Consequently, searches must be carried out efficiently. In view of this, a number of different kinds of search systems have evolved.

An example of one such search system is described in Japanese patent JP-A-H10-269233. The database search system disclosed in this patent concerns a document database that is configured to highlight associated portions located by keyword search in a document. This makes it possible to efficiently find occurrences of data acquired by the search. It does not, however, improve the efficiency of the search itself.

The selection of effective keywords to a large extent determines the efficiency of any such search. A search that returns too many spurious documents is ultimately an inefficient and expensive search, as time must be spent to sift through the results and separate the spurious from the useful. Even when the search is not dominated by spurious returns, a search in a large database often requires a significant effort to interpret, due to its sheer volume.

Consequently, there is a need to improve the efficiency of database searches by selecting keywords effectively.

### SUMMARY

Therefore, an object of the present invention is to provide an input interface that enables a user to select effective keywords, and a search system for using such an input interface in a database search.

The present invention includes an inventive database system comprising a full text search engine for retrieving target data from a database, an input/output control section that controls the input of keywords for searching the database and the output of the search results, and a search system control section that, based on effectiveness measures of the keywords, e.g., the hit ratios of the keywords, determines a display manner of the keywords before the full text search engine searches the database. The input/output control section controls display of the keywords in a display section according to the display manner determined by the search system control section.

The effectiveness measures may include information about the hit ratio or the number of hits of the keyword in the database to be searched, which may be read from a pre established keyword table used by the search engine in conducting the search. The table may include the keywords and the numbers of hits of each of the keywords in the database.

The display manner of the keywords may change their colors and fonts, for example, characters may be decorated, or special symbols may be used to represent characters. Characteristics of the input fields of the interface may also be tailored. For example, the background colors of the entry or input fields for the keywords may be changed. Through these display controls, a user can visually recognize information about the effectiveness of a keyword before a search is conducted.

Further, the present invention includes the following method for supporting the entry of keywords used for conducting a database search. Specifically, the inventive keyword entry support method comprises a first step of receiving entry of a keyword, a second step of acquiring an effectiveness measure of the keyword, e.g., information about a hit ratio or the number of hits of the keyword in the database to be searched, and a third step of displaying the keyword in a display section in a display manner responsive to the effectiveness measure.

The present invention may be embodied in a single computer, or in a system (e.g. server/client system) that has a plurality of computers or other processors connected via a network. Further, the present invention also includes a program product that enables a computer to realize the functions of the foregoing database search system. This program product can be distributed via magnetic disks, optical disks, semiconductor memories, or other media that store the program product, or via a network.

### BRIEF DESCRIPTION OF THE DRAWINGS

FIG. 1 is a diagram showing a schematic configuration of a database search system in a preferred embodiment of the present invention.

FIG. 2 is a diagram showing an example of a hardware configuration of a computer apparatus that implements a search database server or a search terminal device in a preferred embodiment of the present invention.

FIG. 3 is a diagram showing a functional configuration of the search database server in a preferred embodiment of the present invention.

FIG. 4 is a diagram showing examples of a keyword table and a position table.

FIG. 5 is a diagram for explaining n-gram search logic.

FIG. 6 is a diagram showing an example of a color mapping table that may be used in a preferred embodiment of the present invention.

FIG. 7 is a diagram showing a functional configuration of the search terminal device in a preferred embodiment of the present invention.

FIG. 8 is a flowchart for explaining an operation of the search terminal device in a preferred embodiment of the present invention.

FIG. 9 is a diagram showing an example of a display color control for a keyword according to a preferred embodiment of the present invention.

FIG. 10 is a flowchart for explaining an operation of the search database server in a preferred embodiment of the present invention.

FIG. 11 is a diagram showing an example wherein a display font of a keyword is changed depending on the hit ratio of the keyword in the database.

FIG. 12 is a diagram showing an example of how decoration may be applied to display characters of a keyword depending on the effectiveness measure of the keyword.

FIG. 13 is a diagram showing an example of how particular symbols may be applied to keywords depending on their effectiveness measures.

FIG. 14 is a diagram showing an example of how the colors of input fields may be changed depending on the effectiveness measure.

FIG. 15 is a diagram showing a functional configuration for implementing the database search system according to a preferred embodiment of the present invention by a single computer.

### DETAILED DESCRIPTION

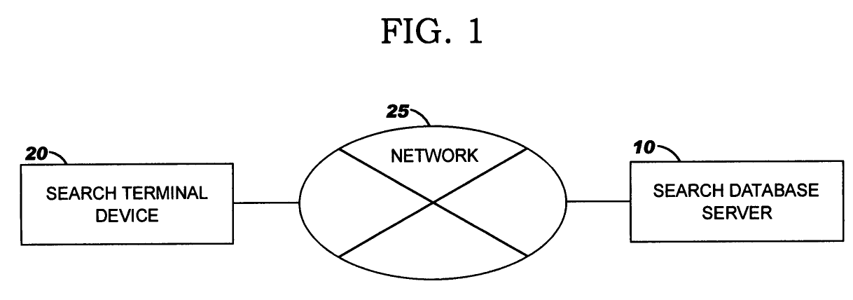

FIG. 1 is a diagram showing a schematic configuration of a database search system according to a preferred embodiment of the present invention which is illustrative of the invention rather than limiting.

As shown in FIG. 1, the exemplary search system includes a search database server 10 having a document database, and a search terminal device 20 that accesses the search database server 10 via a network 25. The following description assumes that the database search system according to this embodiment operates using the World Wide Web, although this is not a necessary condition of the invention.

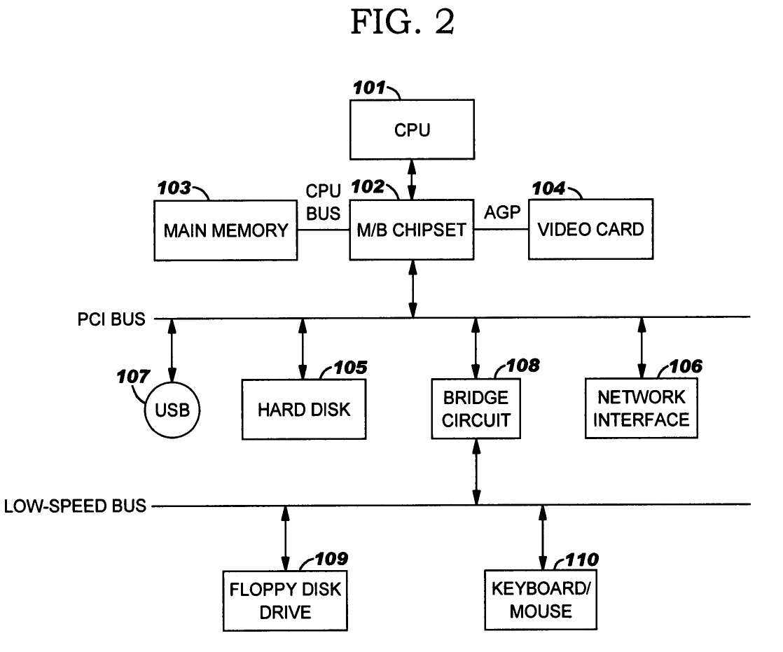

FIG. 2 is a diagram showing an example of a hardware configuration of a computer suitable for implementing the search database server 10 or the search terminal device 20 in this embodiment. The computer apparatus shown in FIG. 2 comprises a CPU (Central Processing Unit) 101, a main memory 103 connected to the CPU 101 via a mother board (M/B) chipset 102 and a CPU bus, a video card 104 likewise connected to the CPU 101 via the M/B chipset 102 and an Accelerated Graphics Port (AGP), a hard disk 105 connected to the M/B chipset 102 via a Peripheral Component Interconnect (PCI) bus, a network interface 106, a USB port 107, a floppy disk drive 109, and a keyboard/mouse 110 connected to the M/B chipset 102 via the PCI bus, a bridge circuit 108, and a low-speed bus such as an Industry Standard Architecture (ISA) bus.

Although FIG. 2 illustrates an exemplary hardware configuration of a computer suitable for implementing the invention, various other configurations can also be employed. For example, instead of providing the video card 104, a video memory may be mounted and image data may be processed by the CPU 101, or a drive for a CD-ROM (Compact Disc Read Only Memory) or, for example, a DVD-ROM (Digital Versatile Disc Read only Memory) may be provided via an interface such as an AT Attachment (ATA).

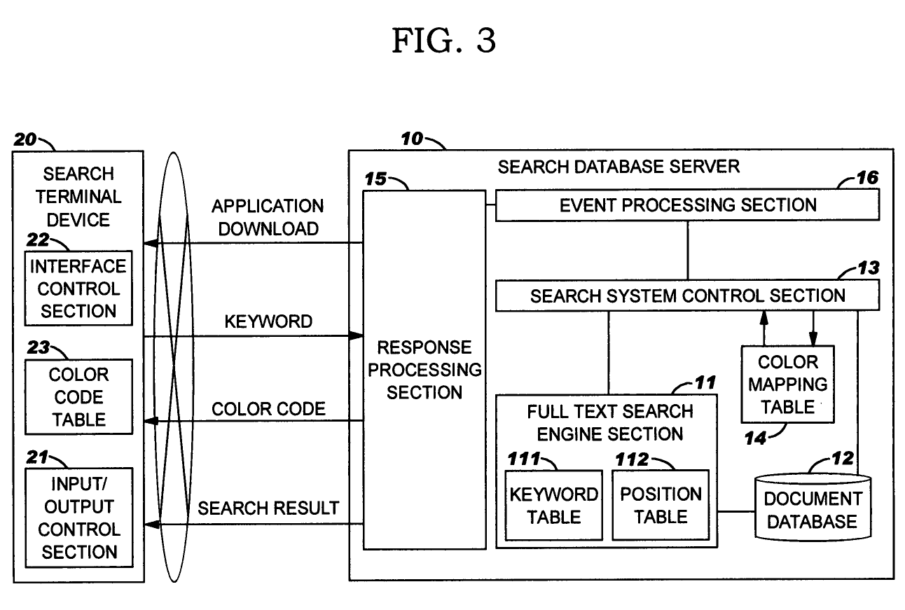

FIG. 3 is a diagram showing a finctional configuration of the search database server 10. As shown in FIG. 3, the search database server 10 comprises a full text search engine section 11, a document database 12, a search system control section 13 for controlling them, a color mapping table 14, a response processing section 15 for responding to an access request from the search terminal device 20, and an event processing section 16 for notifying the search system control section 13 of reception of the access request by the response processing section 15.

When the search database server 10 employs the computer shown in FIG. 2, the full text search engine section 11, the search system control section 13, and the event processing section 16 may be realized by the program-controlled CPU 101, while the response processing section 15 may be realized by the CPU 101 and the network interface 106. A program product for controlling the CPU 101 may be offered through distribution via magnetic disks, optical disks, semiconductor memories or other media that store the program product, or via a network. In the computer apparatus shown in FIG. 2, this program product may be installed in the hard disk 105, and then read and loaded into the main memory 103 to control the CPU 101, thereby realizing the foregoing respective functions. The document database 12 may be realized by the main memory 103 or the hard disk 105, and the color mapping table 14 may also be stored in the main memory 103 or the hard disk 105.

In the foregoing configuration, the full text search engine section 11, which operates based on a predetermined search logic, refers to a keyword table 111 and a position table 112 to retrieve an ID (e.g., a pointer) of a document file, and, based on this ID, reads out target data (e.g., a document) from the document database 12.

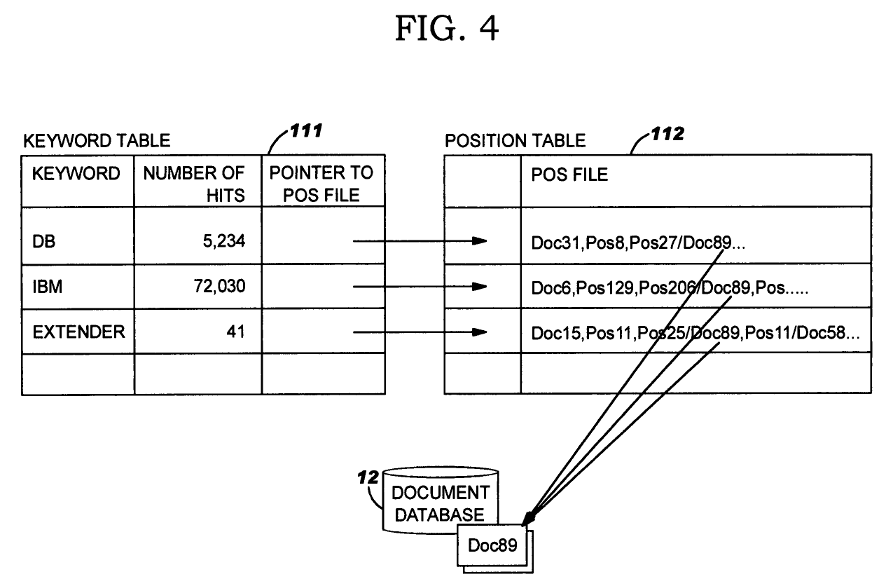

FIG. 4 is a diagram showing exemplary configurations of the keyword table 111 and the position table 112. The keyword table 111 includes keywords, the number of hits of each keyword (i.e. the number of document files including each keyword among all the document files stored in the document database 12), and pointers to POS files registered in the position table 112 and corresponding to the respective keywords.

The position table 112 includes the POS files that are specified by the pointers in the keyword table 111. Each POS file includes descriptions of document files (Doc Numbers) including the corresponding keyword and positions (Pos Numbers) of the keyword in those document files.

Therefore, when a keyword is entered that is present in the keyword table 111, a corresponding POS file can be identified based on a pointer to the POS file registered in the keyword table 111. Then, from the description of the identified POS file in the position table 112, information representing document files including the subject keyword and positions of the subject keyword is acquired so that corresponding document files can be read from the document database 12. In the example shown in FIG. 4, the document file Doc89 includes the keywords “DB”, “IBM” and “EXTENDER” . The input characters may be normalized so as to enable a search respective of font cases.

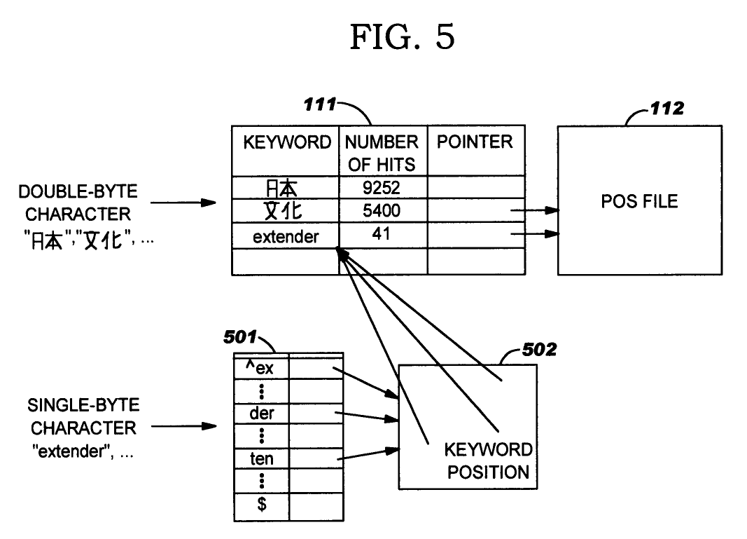

Conventional well-known search logic can be used as the search logic of the fill text search engine section 11. For example, the n-gram method can be used. FIG. 5 explains the n-gram method. In the n-gram method, reference methods differ for double-byte characters such as Chinese characters and single-byte characters such as English characters.

In the case of single-byte characters, special characters are added as delimiters to show the start and the end of each word to be registered. Each word is separated into three characters. Thereafter, these three-character blocks or word pieces are sorted in alphabetical order to produce an index table (reference table 501). Faster processing is now attainable, as the indexes have a fixed length through.

In the keyword table 111, each keyword is registered as a joined word. Among single-byte words registered in the keyword table 111, pointer information for the words corresponding to respective word pieces in the reference table 501 is registered in a relation table 502. Therefore, if pointer information registered in the relation table 502 with respect to word pieces that are obtained by adding the delimiter to a word and separating it into three-character portions, specifies the same word in the keyword table 111, those characters are recognized and fixed.

When the characters are fixed, a corresponding POS file stored in the position table 112 can be identified based on the keyword table 111, so that the information representing document files (Doc Numbers) including the subject keyword and associated positions (Pos Numbers) can be acquired.

On the other hand, in case of double-byte characters, each word is separated into two characters and sorted, and stored in the keyword table 111. Therefore, when characters are fixed, a corresponding POS file stored in the position table 112 can be identified based on the keyword table 111, so that information representing document files (Doc Numbers) including the subject keyword and associated positions (Pos Numbers) can be acquired.

A keyword having two or more characters (including a compound keyword) is stored in the keyword table 111 as two or more keywords. However, inasmuch as each of the two-character pieces specifies a corresponding POS file, when associated positions of the corresponding POS files are analyzed and judged to be continuous positions of the same document file, those word pieces can be recognized as continuous keywords.

As described above, the number of hits of each keyword is registered in the keyword table 111. This number of hits may be obtained by analyzing the content of a document file when the document file is first stored in the document database 12, and registered in the keyword table 111. Further, when the document file stored in the document database 12 is updated, the number of hits is changed according to the change in the document's content. The number of hits registered in the keyword table 111 may be used to optimize a search that has a plurality of keywords in “AND” condition (i.e. when searching for a document file including all the keywords) by starting the search using the keyword with the least number of hits.

In the example of FIG. 4, when searching for document files each including three keywords, e.g., the keywords “DB”, “IBM” and “EXTENDER”, a search that starts with “IBM” returns 72,030 hits, from which document files that also include “DB” and further include “EXTENDER” must be selected. On the other hand, if the search starts with “EXTENDER”, only 41 document files are hit, from which document files including “DB” and further including “IBM” can be retrieved. In this manner, when setting a search condition by combining keywords and conducting a database search, it is possible to reduce the number of steps required by conducting the search based on keywords that have the smallest numbers of hits.

In this embodiment, the search terminal device 20 is given an effectiveness measure of a keyword, based, for example, on the number of hits, before a search is started. Details of this process will be described later.

In FIG. 3, the search system control section 13 executes various controls for searching the document database 12 using the full text search engine section 11. Specifically, the search system control section 13 normalizes characters entered as keywords, reads out documents that are hit in a search by the search engine section 11, and so forth. Further, in this embodiment, the search system control section 13 performs a color mapping process using the color mapping table 14. In the color mapping table 14, the effectiveness measures such as the hit ratios (i.e., the number of hits divided by the number of all the documents stored in the document database 12) of the keywords are classified into proper ranges, and various colors are associated with the keywords based on the ranges of the hit ratios.

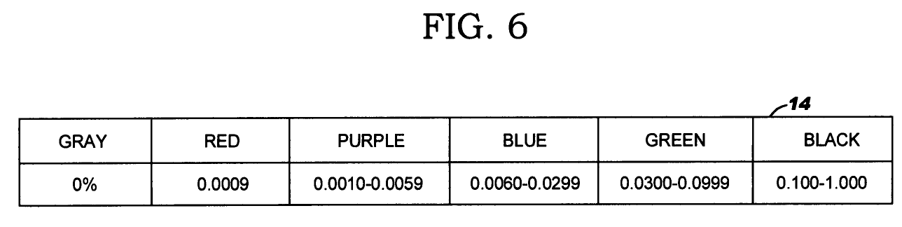

FIG. 6 is a diagram showing an example of the color mapping table 14. In this example, the color red is allocated to a keyword having a hit ratio of 0.0009 or less (but not including a hit ratio of 0; in the figure, * represents a hit ratio when the number of hits is 1), the color purple is allocated to a keyword having a hit ratio of 0.0010 to 0.0059, the color blue is allocated to a keyword having a hit ratio of 0.0060 to 0.0299, the color green is allocated to a keyword having a hit ratio of 0.0300 to 0.0999, and the color black is allocated to a keyword having a hit ratio of 0.1000 or higher. Further, the color gray is allocated to a keyword that has a hit ratio of 0.0000.

When a keyword is entered, the search system control section 13 refers to the keyword table 111 to acquire the number of hits of the subject keyword, calculates a hit ratio, and allocates a color to the subject keyword by referring to the color mapping table 14. As described later, the color allocated to the keyword is used as a display color to display the subject keyword in the search terminal device 20.

The response processing section 15 receives an access request from the search terminal device 20 and carries out various response processes. Specifically, the response processing section 15 first transmits an application program for database search to the search terminal device 20. This application program may be a Java (trademark of Sun Microsystems, Inc.) applet or the like. Under the control of this application program, the response processing section 15 transmits a color code table for specifying colors for displaying characters in the display section of the search terminal device 20. Further, the response processing section 15 receives a keyword and sends it to the search system control section 13 via the event processing section 16. The response processing section 15 transmits, to the search terminal device 20, a color code of the keyword sent from the search system control section 13 before executing a search, a search result (presence/absence of associated document files, and information for identifying those document files), and the document files sent from the search system control section 13 after the execution of the search.

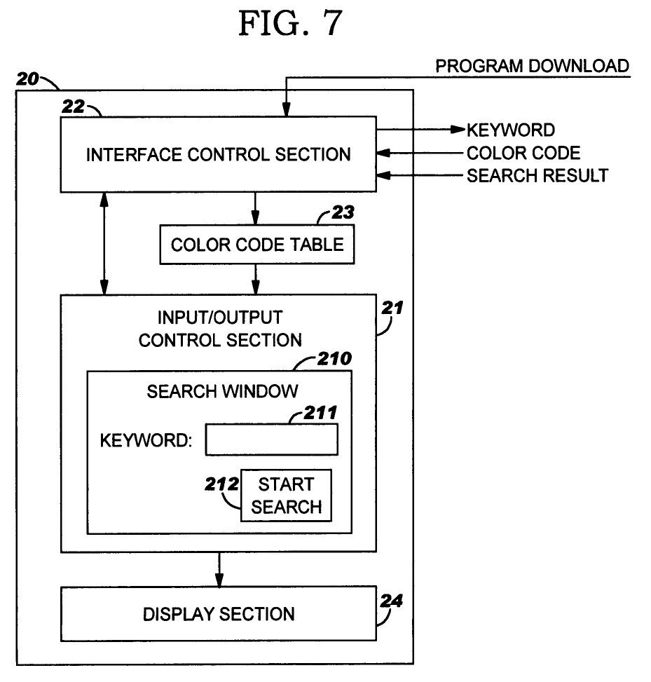

FIG. 7 shows an exemplary functional configuration of the search terminal device 20 in this embodiment. As shown in FIG. 7, the search terminal device 20 comprises an input/output control section 21 for a user interface, an interface control section 22, a color code table 23, and a display section 24. The input/output control section 21 may be realized by a web browser (for example, the Internet Explorer of Microsoft Corporation, the Netscape Navigator of Netscape Communications Corporation, or the like). The interface control section 22 may be realized by the application program for database search downloaded from the search database server 10 via the network 25. When the search terminal device 20 is implemented using the computer apparatus shown in FIG. 2, the program is read and loaded into the main memory 103 and controls the CPU 101 to work as the interface control section 22 and the input/output control section 21. The color code table 23 is transmitted from the search database server 10 via the network 25 and stored in the main memory 103 or the hard disk 105. The display section 24 may be a CRT display, a liquid crystal display, or the like.

The input/output control section 21 displays, in the display section 24, a search window 210 for performing a database search. Data (e.g., an HTML document) of the search window 210 is acquired from the interface control section 22. The search window 210 is provided with an input field 211 for entering a keyword, and a button icon 212 for issuing a start-search command. In response to this input operation, the input/output control section 21 delivers the keyword to the interface control section 22, or issues the start-search command. When a search hits a document file, the input/output control section 21 can issue a read request command for reading out the hit document file, responsive to an indication from the user.

The interface control section 22 transmits the keyword to the search database server 10, along with the start-search command and the read request command or the like entered using the input/output control section 21, receives the search result or the hit document file from the search database server 10, and delivers it to the input/output control section 21. This search result is displayed in the search window 210 by the input/output control section 21. The hit document file is displayed in the search window 210, or in the display section 24.

The color code table 23 corresponds to the color mapping table 14, which defines a relationship between color codes for specifying display colors of characters of keywords, and display colors of keywords that are actually displayed in the search window 210 by the input/output control section 21. Although details will be described later, the input/output control section 21, based on a color code acquired from the interface control section 22 and the correspondence relationship defined by the color code table 23, displays a keyword in the corresponding display color.

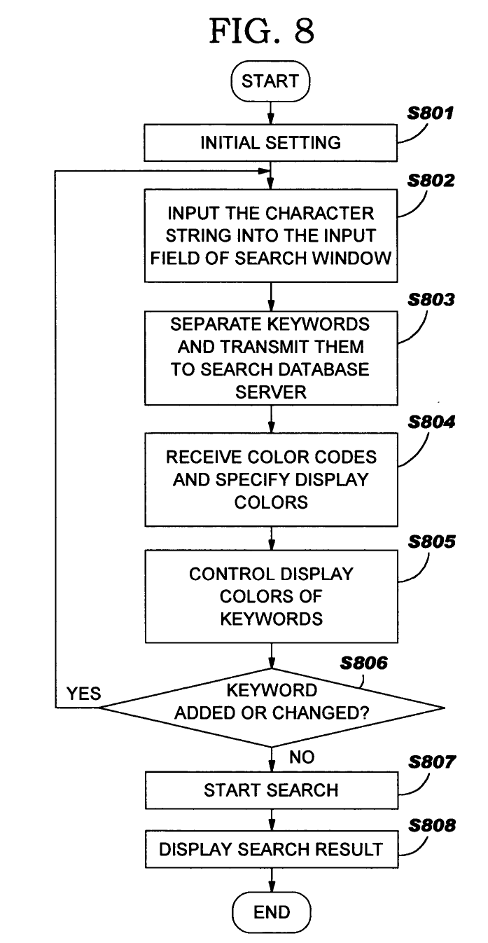

FIG. 8 is a flowchart showing an operation of the search terminal device 20 in an exemplary database search system configured as described above. Here, the application program for database search and the color code table 23 have been downloaded initially from the search database server 10 to the search terminal device 20, and the input/output control section 21 and the interface control section 22 have been started (step S801).

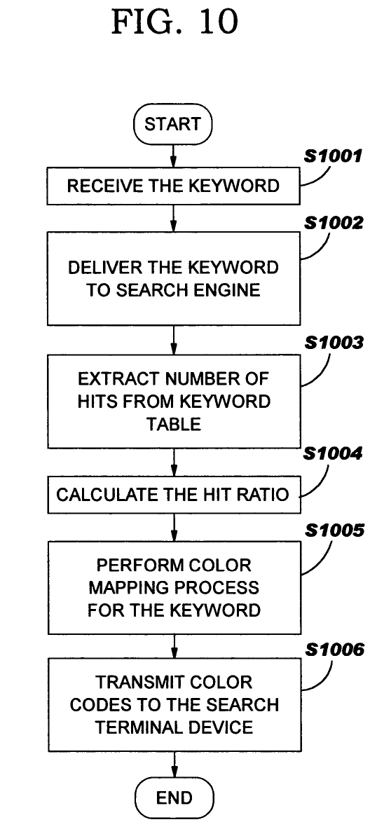

As shown in FIG. 8, when a character string is entered into the input field 211 in the search window 210 displayed in the display section 24 of the search terminal device 20 (step S802), the input character string is delivered from the input/output control section 21 to the interface control section 22. When a special character representing punctuation of a keyword, such as a space or comma, is entered into the input field 211, the interface control section 22 may separate the keyword at the punctuation and transmit the separated parts to the search database server 10 via the network 25 (step S803). The search data base server 10 calculates effectiveness measures such as hit ratios for these keywords, and performs the color mapping process (see FIG. 10, which will be described later).

When color codes are transmitted from the search database server 10 to the search terminal device 20, the interface control section 22 specifies display colors of the keywords based on the received color codes and the color code table 23 (step S804). Then, the input/output control section 21 controls the display colors of the keywords (step S805).

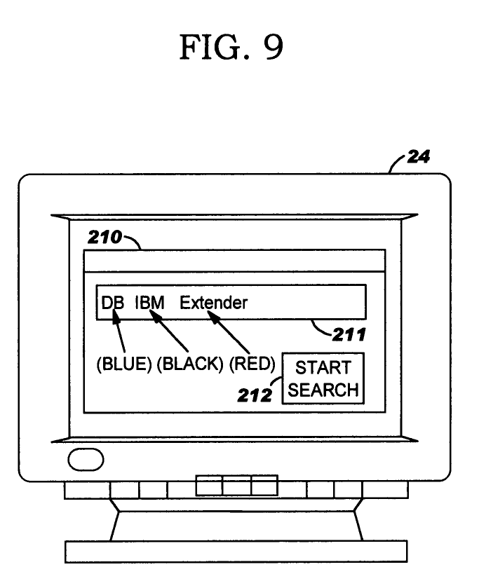

FIG. 9 shows an example of controlling the display colors of keywords. FIG. 9 assumes that the color codes of blue, black and red were transmitted from the search database server 10 for the keywords of “DB”, “IBM” and “Extender”, respectively, which were entered into the input field 211 of the search window 210. Accordingly, by referring to the color code table 23, the characters of “DB” are displayed in blue, the characters of “IBM” are displayed in black, and the characters of “Extender” are displayed in red.

Upon viewing this display, a user of the search terminal device 20 can judge whether or not the keywords are effective. Specifically, assuming that the display colors of the respective keywords shown in FIG. 9 follow the color mapping table 14 shown in FIG. 6, “Extender,” which is displayed in red, has a low hit ratio, and is therefore effective for narrowing a search. On the other hand, “IBM,” which is displayed in black, has a high hit ratio, and is therefore not so effective. In this example, inasmuch as the keyword “Extender” is highly effective, the search may be continued. On the other hand, when all the keywords are displayed in colors like black or green, which indicate high hit ratios, many document files are hit in a search, and post-search evaluation can be expected to be laborious. Therefore, before staring the search, it is possible to add or substitute a new keyword. When a keyword is added or substituted, the search terminal device 20 repeats the foregoing operation at steps S802 to S805 (step S806).

If the keywords are not changed, a start-search command is issued from the input/output control section 21 in response to the user's instruction to execute a search, and sent to the search database server 10 via the interface control section 22 (step S807). Then, when a search result is sent from the search database server 10, the search result is received at the interface control section 22, and displayed in the search window 210 by the input/output control section 21 (step S808)

In this example, when a special character representing the punctuation of a keyword is entered into the input field 211 of the search window 210, the keyword is divided and sent to the search database server 10. On the other hand, the system may also be configured to ignore the special character and recognize the entry as a single keyword, which is sent to the search database server 10.

A combination of constituent keywords may be stored in the keyword table 111 and used as a compound keyword (e.g., by inserting a special character between the constituent keywords like “JAPAN!IBM”). When words of “JAPAN!IBM” are entered as a compound, a search can be conducted with the single keyword “JAPAN IBM” in addition to the separate keywords “JAPAN” and “IBM”. When a compound keyword exists in the keyword table 111, a display color control is executed to display a hit ratio or other effectiveness measure of this compound keyword as a unit, whereas, if the compound keyword does not exist in the keyword table 111, a display color control is executed to display hit ratios of the individual components of the compound keyword.

FIG. 10 is a flowchart showing an exemplary operation of the search database server 10. Here, the response processing section 15 of the search database server 10 has initially received an access request from the search terminal device 20 and transmitted the application program for database search and the color code table 23.

As shown in FIG. 10, when a keyword from the search terminal device 20 is received at the response processing section 15 of the search database server 10 (step S1001), the keyword is processed in the event processing section 16 and delivered to the search system control section 13. Any normalization processing is carried out, and the delimiters are added when the keyword is a single-byte character. Then, the keyword is delivered to the full text search engine section 11 (step S1002).

The full text search engine section 11 checks whether or not the keyword is present in the keyword table 111. If the keyword is present, its effectiveness measure is determined. For example, the number of hits for the keyword may be found (step S1003), and the hit ratio calculated by dividing the number of hits by the number of all the document files stored in the document database 12 (step S1004). The calculated hit ratio is delivered from the full text search engine section 11 to the search system control section 13.

The search system control section 13 correlates the obtained hit ratio of the input word with the color mapping table 14 and implements the color mapping process to determine a display color for the keyword (step S1005). Then, the display color code is delivered to the response processing section 15 via the event processing section 16 and sent to the search terminal device 20 (step S1006). The keyword is then displayed in the search terminal device 20 in the selected color.

As described above, the calculation of the hit ratio of the keyword and the color mapping process are performed in the search database server 10, and the color display of the keyword is carried out in the search terminal device 20 based on the color code acquired from the search database server 10. Then, after referring to the hit ratios of the keywords identified by the display colors and changing the keywords if necessary, the user determines the final selection of keywords and issues the start-search command (e.g., by clicking a button icon). The start-search command is issued and sent from the search terminal device 20 to the search database server 10 where the normal search processing is implemented, and the search result (presence/absence of document files including the keyword, and information for identifying those document files) is transmitted to the search terminal device 20. Thereafter, if necessary, the target document files can be read out based on the information included in the search result.

As described above for this embodiment, the effectiveness measure of a keyword is the hit ratio of the keyword, which is calculated based on the information about the number of hits of the keyword appearing in the existing keyword table 111. The effectiveness measure of the keyword is expressed by the display color so as to be visually distinct to the user. However, when database to be searched is enormous, a more suitable effectiveness measure may be the numbers of hits rather than the hit ratios, in order to provide a basis for estimating the time and labor needed to interpret the search and check the document files after the search is executed. In view of this, the inventive search system may also be configured to display the numbers of hits according to the color code rather than the hit ratios. For example, the color red might be allocated to a keyword having 50 or fewer hits, the color blue allocated to a keyword having 51 to 100 hits, and the color black allocated to a keyword having more than 100 hits.

The foregoing embodiment is configured to download initially, from the search database server 10 to the search terminal device 20, both the application program giving the function of the interface control section 22 to the search terminal device 20, and the color code table 23. However, these components may also be stored in optical disks or other storage media and distributed in advance.

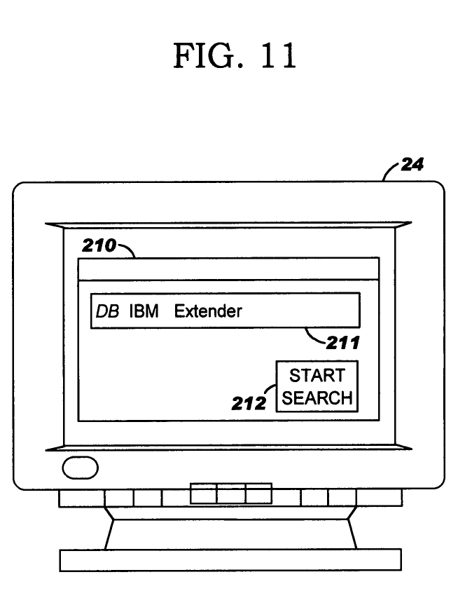

Hit ratios, numbers of hits, or other effectiveness measures may be displayed in a variety of ways other than, or in addition to, changing display colors. For example, FIG. 11 shows how a display font of a keyword can be changed depending on an effectiveness measure, in this case a hit ratio. Here, the search database server 10 is provided with, rather than the color mapping table 14, a mapping table that stores hit ratios or numbers of hits of keywords, classified into proper ranges, and information about the allocation of display fonts of characters. The search system control section 13 refers to this mapping table and determines, depending on a hit ratio of a keyword, a display font for the keyword. Following the determination of the search system control section 13, the response processing section 15 transmits a font code to the search terminal device 20.

In the search terminal device 20, the interface control section 22 identifies the display font of the keyword based on the received font code, and the input/output control section 21 displays the keyword using the subject display font.

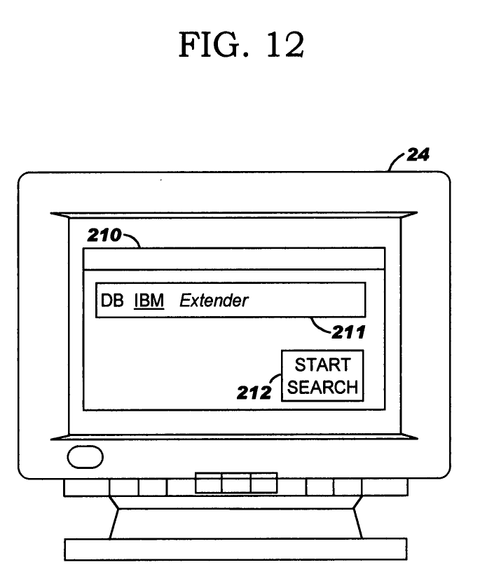

As a further example, FIG. 12 shows how decorations may be applied to display characters of keywords depending on their effectiveness measures. In this case, the search database server 10 is provided with, instead of the color mapping table 14, a mapping table that stores the effectiveness measures of keywords, classified into proper ranges, along with information defining character decorations. Characters may be decorated by making them bold, italicized, underlined, half-toned dot meshed, and so forth. Then, the search system control section 13 refers to this mapping table and determines, depending on, for example, a hit ratio of a keyword, the decoration to be applied to characters of the keyword. Following the determination of the search system control section 13, the response processing section 15 transmits a code that identifies a kind of decoration to the search terminal device 20.

In the search terminal device 20, the interface control section 22 identifies the decoration based on the received code, and the input/output control section 21 displays the keyword using the decorative characters.

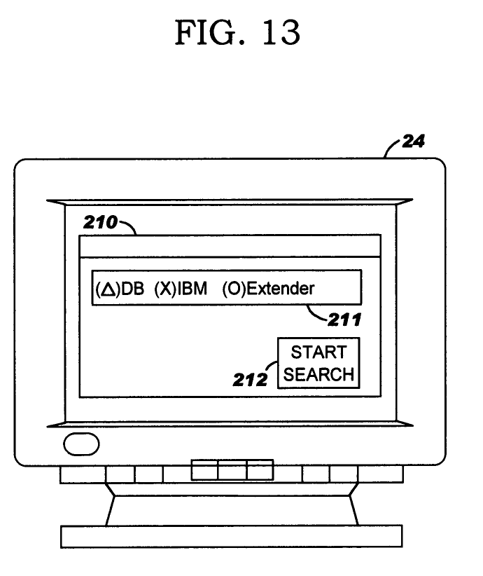

As yet another example, FIG. 13 shows how particular symbols may be used to distinguish keywords depending on their effectiveness measures. In this case, the search database server 10 is provided with, instead of the color mapping table 14, a mapping table that stores effectiveness measures of keywords, classified into proper ranges, along with information about the allocation of predetermined symbols. Then, the search system control section 13 refers to this mapping table and determines a symbol (“delta”, X, O in the example shown) to be added to the keyword. Following the determination of the search system control section 13, the response processing section 15 transmits a code of the determined symbol to the search terminal device 20.

In the search terminal device 20, the interface control section 22 identifies the symbol to be given to the keyword based on the received code, and the input/output control section 21 displays a character string of the keyword using the subject symbol.

In addition to the foregoing, it is also possible to change the display size of a keyword depending on an effectiveness measure.

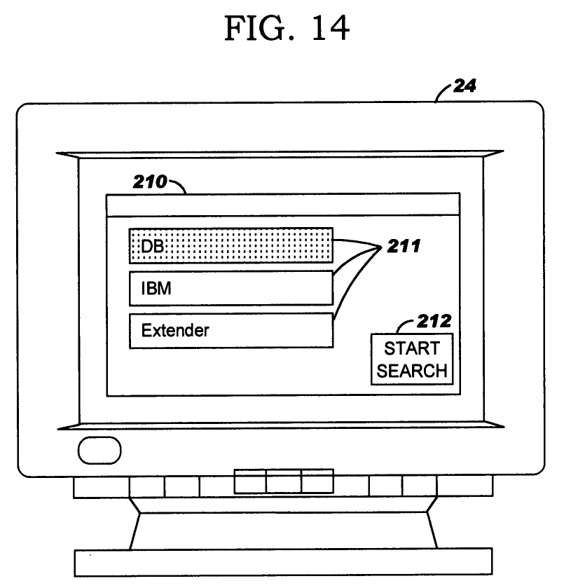

Further, the background of the input field 211 may be changed. FIG. 14 shows the state in which a display color of each of the input fields 211 where keywords are entered, is changed depending on effectiveness measures of the keywords.

Another exemplary configuration of the database search system is further described below. In the foregoing embodiment, as shown in FIG. 1, the search request is made from the search terminal device 20 to the search database server 10 over the network 25. On the other hand, the present invention applies as well to a database search system implemented by a single computer.

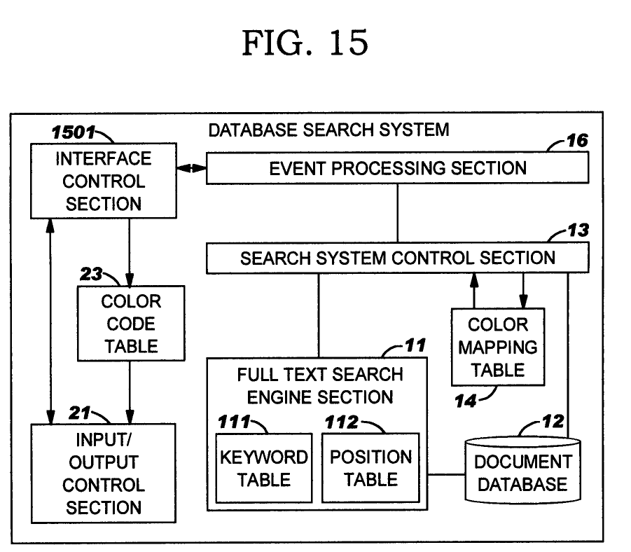

FIG. 15 is a diagram showing a configuration of a database search system realized by a single computer. The database search system shown in FIG. 15 comprises a full text search engine section 11, a document database 12, a search system control section 13 for controlling them, a color mapping table 14, an event processing section 16, an input/output control section 21, a color code table 23, and an interface control section 1501. Inasmuch as the full text search engine section 11, the document database 12, the search system control section 13, the color mapping table 14 and the event processing section 16 are substantially the same as the respective components in the search database server 10 shown in FIG. 3, description thereof is omitted, and they are assigned the same reference symbols. Likewise regarding the input/output control section 21 and the color code table 23, which are substantially the same as those in the search terminal device 20 of FIG. 7.

The interface control section 1501 receives a keyword, a start-search command, a read request command, or the like entered via the input/output control section 21, and sends these to the search system control section 13 via the event processing section 16. The interface control section 1501 delivers, to the input/output control section 21, a color code of the keyword sent from the search system control section 13 before the execution of a search. After the execution of the search, the interface control section 13 sends the search result (presence/absence of associated document files, and information for identifying those document files) and the document files. Namely, the interface control section 1501 has the functions of both the response processing section 15 in the search database server 10 shown in FIG. 3, and the interface control section 22 in the search terminal device 20 shown in FIG. 7. When the database search system is implemented using the computer apparatus shown in FIG. 2, the interface control section 1501 may be realized by the program-controlled CPU 101.

The foregoing has described an exemplary embodiment wherein the document database 12 storing the document files is provided, and this document database 12 is searched. In sites for searching web pages on the Internet, databases do not store document files (HTML documents) themselves, but store Uniform Resource Locators (URLs) representing locations of document files, and text data (part or full) of the document files. The present invention applies to this case as well; it is possible to control the display manner of a keyword responsive to an effectiveness measure such as the hit ratio or the number of hits based on the text data portions.

Further, the database search system and its keyword entry support method according to the present invention are also applicable to various databases other than the document database 12. When searching a database other than a document database, it is not necessary that a keyword be literally a word from a natural language; rather, the invention encompasses searches involving other kinds of characters, objects, data, and structures as well.

Further, the foregoing exemplary embodiments assume that the database search system operates on the World Wide Web, and the input/output control section 21 displays a keyword using a web browser. However, the present invention does not require either the web or the web browser as a necessary condition. Under the control of a program other than a web browser, the input/output control section 21 can display the search window 210 in the display section 24, receive an entered keyword, and control the display manner of the keyword according to an effectiveness measure.

According to the present invention, as described above, it is possible to provide an input interface that facilitates effective selection of keywords, and a system using such an input interface in a database search. This makes it possible to reduce the frequency of repeating searches while trying various keywords, thereby simplifying a user's burden and lowering the load on a database search system.

I claim:

1. A database system comprising:
a search engine for searching a database;
an input/output control section that controls input of a keyword and output of a search result found by searching the database using the search engine; and
a search system control section that determines a display manner of the keyword responsive to an effectiveness measure of the keyword before the search is performed;
wherein the input/output control section displays the keyword on a predetermined display section in the display manner determined by the search system control section.

2. The database system of claim 1, wherein the effectiveness measure is a hit ratio of the keyword in the database.

3. The database system of claim 1, wherein the effectiveness measure is a number of hits of the keyword in the database.

4. A database system according to claim 1, wherein the display manner specifies a color, and the input/output control section displays the keyword in the specified color.

5. A database system according to claim 1, wherein the search system control section acquires the effectiveness measure of the keyword by referring to a table that includes the keyword and the number of hits of the keyword in the database.

6. A database system according to claim 1, wherein the input/output control section separates the keyword into parts, based on a special character representing punctuation of the keyword, and the search system control section determines display manners of the parts.

7. A terminal device comprising:
input control means for receiving a keyword for use in a database search and displaying the keyword using a display section; and
display manner control means for controlling a display manner of the keyword that is displayed using the display section, based on an effectiveness measure of the keyword.

8. The terminal device of claim 7, wherein the effectiveness measure is a hit ratio of the keyword in the database.

9. The terminal device of claim 7, wherein the effectiveness measure is a number of hits of the keyword in the database.

10. A terminal device according to claim 7, wherein the display manner control means changes a display color of the keyword responsive to the effectiveness measure of the keyword.

11. A terminal device according to claim 7, wherein the display manner control means changes a font of the keyword responsive to the effectiveness measure.

12. A terminal device according to claim 7, wherein the display manner control means selects character decoration to display the keyword responsive to the effectiveness measure.

13. A terminal device according to claim 7, wherein the display manner control means uses a predetermined symbol to display the keyword responsive to the effectiveness measure.

14. A terminal device according to claim 7, wherein the input/output control section separates the keyword into parts, based on a special character representing punctuation of the keyword, and the search system control section determines display manners of the parts.

15. A search database server that receives a keyword from an input terminal and conducts a database search using the keyword, said search database server comprising:
a search engine for searching a database;
a search system control section for acquiring an effectiveness measure of the keyword in the database before the search engine searches the database; and
a response processing section for sending, to the input terminal, information about the effectiveness measure of the keyword acquired by the search system control section.

16. The search database server of claim 15, wherein the effectiveness measure is a hit ratio of the keyword in the database.

17. The search database server of claim 15, wherein the effectiveness measure is a number of hits of the keyword in the database.

18. A search database server according to claim 15, wherein the search system control section acquires, per keyword, effectiveness measures of a plurality of keywords by referring to a table that includes the plurality of keywords and corresponding numbers of hits of the keywords in the database, said table used by the search engine.

19. A keyword entry support method for database searches, said method comprising:
receiving a keyword entered by a user;
acquiring information about effectiveness of the keyword; and
displaying the keyword in a display manner responsive to the acquired information about effectiveness.

20. A keyword entry support method according to claim 19, wherein the step of acquiring information about effectiveness includes a step of determining a number of hits of the keyword in the database, and the step of displaying includes a step of specifying a display manner of the keyword responsive to the effectiveness of the keyword.

21. A keyword entry support method according to claim 20, wherein effectiveness is determined by referring to a table that includes the keyword and the number of hits of the keyword in the database, said table used by the search engine.

22. A program product enabling a computer to conduct a database search using a keyword entered from an input terminal, said program product causing the computer to function as:
search means for searching a database;
search system control means for acquiring an effectiveness measure of the keyword before searching the database; and
response processing means for sending information about the effectiveness measure of the keyword to the input terminal.

23. A program product for enabling a computer to support input of a keyword used for searching a database, said program product including program instructions for modules comprising:
an input control module for receiving entry of a keyword for searching a database and displaying the keyword in a display section; and
a display manner control module for controlling a display manner of the keyword on the display section responsive to an effectiveness measure of the keyword.

24. A program product according to claim 23, wherein the display manner control module causes the computer to change a display color of the keyword responsive to the effectiveness measure.
